(19) United States
(12) Patent Application Publication
(10) Pub. No.: US 2018/0227720 A1
(43) Pub. Date: Aug. 9, 2018

(54) METHOD AND SYSTEM FOR PROVIDING INFORMATION DATA

(71) Applicant: Siemens Aktiengesellschaft, München (DE)

(72) Inventor: Andreas Ziller, Oberhaching (DE)

(21) Appl. No.: 15/750,017

(22) PCT Filed: Jul. 14, 2016
(86) PCT No.: PCT/EP2016/066759

§ 371 Date: Feb. 2, 2018

(30) Foreign Application Priority Data
Aug. 3, 2015 (DE) 10 2015 214 740.1

(51) Int. Cl. H04W 4/20; H04W 4/60; H04L 29/08

(52) U.S. Cl. CPC H04W 4/20; H04W 80/12; H04L 67/26; H04W 4/60

(57) ABSTRACT

Method and system for providing information data using a notification system for an application of a terminal is provided. The steps include: reception of a notification registration by the notification system from the terminal during registration of the terminal with the notification system; transmission of a notification which contains information data as notification content; derivation of the notification token by a web service, addressed by the notification address, of a gateway component from a call parameter obtained, the derived notification token being transmitted to a delivery system together with the information data or an access address for accessing the information data; identification of the terminal by the delivery system on the basis of the notification token obtained, and forwarding of the information data or the access address for accessing the information data to the application of the identified tenninal by the delivery system.

The invention relates to a method and a system for a notification system to provide information data for an application of a terminal.

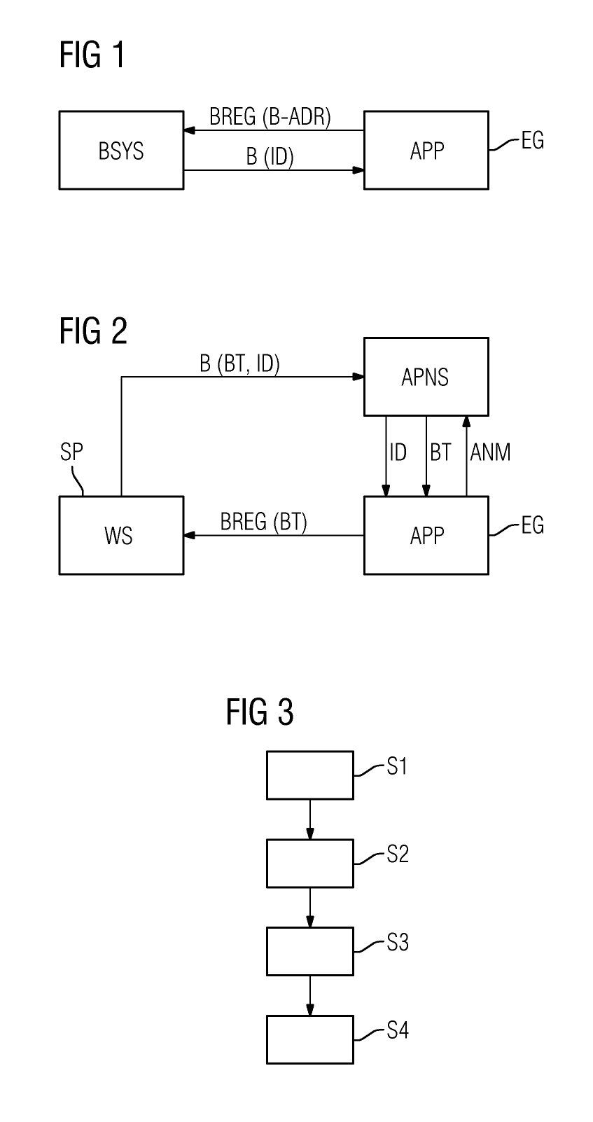

FIG. 1 shows a conventional asynchronous notification system that provides notification to a terminal. The terminal, for example a portable terminal, has at least one application APP executed on it. First of all, the terminal EG uses a network to transmit a notification registration BREG that the terminal EG uses to sign in on the notification system BSYS to receive notifications B. This notification registration or subscription usually includes a notification address or URL (Uniform Resource Locator) to which the notifications B need to be sent by the notification system BSYS. Further, the notification registration usually includes a notification rule that, when complied with, triggers on the notification system BSYS the sending of a notification B with information data ID. If an event that complies with the notification rule arises on the notification system BSYS, the notification system BSYS sends an applicable notification B with the information data to the application APP executed on the terminal EG. The notification address B-ADR specified in the notification registration BREG is used as soon as a notification B is triggered in order to send the terminal EG the information data ID in the notification B. A conventional asynchronous notification system BSYS, as depicted schematically in FIG. 1, is implemented according to the Sensor Event Service (SES) specification of the Open Geospatial Consortium (OGC), for example. Asynchronous notifications systems of this kind use a web service call to notify the receivers or the terminals. This requires a server process to be able to accept connections on a TCP port or receive data on a UDP port. This is frequently not possible, not just on account of the security policies of the network operators. Some terminals EG that are behind NATs or in mobile radio networks cannot accept such connections. Even if there is nothing on the network against the provision of a web service, their operating system means that they are not suitable for an asynchronous notification system. Such terminals EG are terminals that are equipped with the operating system IOS, for example. Neither iPhones nor iPads from all generations are capable of accepting incoming TCP or UDP connections. This is prevented by the IOS operating system implemented on the terminal EG.

To nevertheless allow users of IOS terminals to receive asynchronously provided messages, the device manufacturer Apple therefore provides what is known as the Apple Push Notification Service (APNS). This service forwards messages or notifications and applications from third parties to Apple terminals. The APNS service as depicted schematically in FIG. 2, can be used by applications APPs that are executed on an Apple terminal EG equipped with the operating system IOS in order to allow special applications that require the IOS terminal to obtain notifications or information data without being asked. In this manner, the application of the IOS terminal can obtain applicable information data without being asked when an applicable event occurs. In the case of an Apple Push Notification Service, APNS, as depicted schematically in FIG. 2, the terminal EG first of all signs in on the delivery or forwarding system APNS and obtains a notification token BT when the system starts. This notification token BT can be used by the IOS terminal EG when registering with a service provider SP. When an event occurs, the web service WS sends a notification B to the proprietary delivery or forwarding system APNS, as depicted in FIG. 2. The notification B includes information data ID and also the notification token BT of the terminal EG that the service provider obtained during registration as notification content. The proprietary delivery system APNS compares the notification tokens BT assigned when the system started with the notification token received in the notification B in order to identify the applicable terminal EG. Subsequently, the delivery service APNS delivers the notification content or the information data ID to the identified terminal as depicted in FIG. 2.

The delivery system APNS, as depicted in FIG. 2, is proprietary, however, and cannot be used by a conventional notification system BSYS, as depicted schematically in FIG. 1.

It is therefore an object of the present invention to provide a method and a system for providing information data that allow notifications that are generated by a conventional notification system BSYS to be transmitted to terminals EG using a proprietary delivery system too.

This object is achieved according to the invention by a method having the features specified in patent claim 1.

According to a first aspect, the invention provides a method for a notification system to provide information data for an application of a terminal, having the steps: the notification system receives a notification registration from the terminal when the terminal registers with the notification system, the received notification registration having a notification address for addressing a web service provided by a gateway component and a call parameter that is dependent on a notification token of the terminal, the notification system sends a notification that includes information data as notification content to the notification address included in the notification registration, the web service of the gateway component that is addressed by the notification address derives the notification token from the obtained call parameter, the derived notification token being transmitted together with the information data or an access address for accessing the information data to a delivery system, and the delivery system identifies the terminal (EG) on the basis of the obtained notification token, and the delivery system forwards the information data or the access address for accessing the information data to the application of the identified terminal.

The method according to the invention affords the advantage that the information data can be reliably provided to the terminal without a conventional notification system or a proprietary delivery system needing to be altered. The method according to the invention can be used by applications or application programs (APPs) on a terminal that needs information data of an asynchronous notification system.

In one possible embodiment of the method according to the invention, the terminal obtains an explicit notification token from the delivery system after the terminal has signed in on the delivery system.

In a further possible embodiment of the method according to the invention, the terminal generates the call parameter by virtue of a prescribed generator function being applied to the obtained notification token.

In a further possible embodiment of the method according to the invention, the notification address is formed by concatenation of an address of the gateway component, a port number of the web service, an address path for calling the web service and the call parameter.

In a further possible embodiment of the method according to the invention, the notification that is sent by the notification system and includes the information data as notification content is triggered by an event.

In a further possible embodiment of the method according to the invention, the web service of the gateway component that is addressed by the notification address derives the notification token from the obtained call parameter by virtue of an inverse function of the prescribed generator function being applied to the call parameter.

In a further possible embodiment of the method according to the invention, the gateway component generates an associated key for an obtained notification if the amount of data in the notification obtained from the notification system exceeds an admissible maximum amount of data, and stores the notification content of the obtained notification together with the associated key for referencing the notification content in a local memory of the gateway component.

In a further possible embodiment of the method according to the invention, the gateway component generates for the notification obtained from the notification system an access address for accessing the information data included in the notification as notification content if the amount of data in the notification obtained from the notification system exceeds an admissible maximum amount of data.

In a further possible embodiment of the method according to the invention, the gateway component transmits the generated access address for accessing the information data obtained in the obtained notification, which has the generated key, together with the notification token derived from the notification address to the delivery system, which uses the notification token to identify the terminal and forwards the access address, including the key, to the application of the identified terminal.

In a further possible embodiment of the method according to the invention, the access address for accessing the information data is generated by the gateway component by concatenation of an address of the gateway component, a port number of the web service, an address path for calling the web service and the key generated for the notification.

In a further possible embodiment of the method according to the invention, the application of the identified terminal calls the web service of the gateway component that is addressed in the access address, said gateway component using the key included in the access address to reference the associated notification content of the notification that is stored in the local memory of the gateway component.

In a further possible embodiment of the method according to the invention, the notification content of the notification that is referenced by the key is read from the local memory of the gateway component by the called web service and transmitted to the application of the terminal to evaluate the information data that form the notification content.

In one possible embodiment of the method according to the invention, the gateway component generates the key by means of a cryptographic hash function.

According to a further aspect, the invention further provides an information system having the features specified in patent claim 14.

he invention accordingly provides an information system for a notification system to provide information data for at least one application of a terminal having limited communication capability,

wherein the notification system is designed to automatically send a notification that includes information data as notification content to a notification address that comes from a notification registration for registering the terminal with the notification system that has the notification address for addressing a web service provided by a gateway component and a call parameter that is dependent on a notification token of the terminal,
wherein the web service of the gateway component that is addressed by the notification address derives the notification token from the obtained call parameter and transmits it together with the information data or an access address for accessing the information data to a delivery system that is designed to identify the terminal on the basis of the obtained notification token and to forward the information data or the access address for accessing the information data to the application of the identified terminal.

In one possible embodiment of the information system according to the invention, the notification system and the gateway component are integrated in a server of a service provider.

In a further possible embodiment of the information system according to the invention, the delivery system is a proprietary delivery system, particularly an APNS system.

In a further possible embodiment of the information system according to the invention, the terminal is a terminal having limited communication capability for push mode, particularly an IOS device.

In a further possible embodiment of the information system according to the invention, the information system provides traffic-related and/or environment-related data to a navigation application for route calculation using push mode, which navigation application is executed on the terminal having limited communication capability, as information data.

According to a further aspect, the invention provides a gateway component having the features specified in patent claim 19.

The invention accordingly provides a gateway component for an information system according to the second aspect of the invention,

wherein the gateway component receives a notification from a notification system via a notification address for addressing a web service provided by the gateway component, which notification has a call parameter that is dependent on a notification token of a terminal,
wherein the addressed web service derives the notification token of the terminal from the call parameter and transmits the derived notification token together with the notification content of the received notification or an access address for accessing the notification content of the received notification to a delivery system of the terminal.

Possible embodiments of the method according to the invention and of the information system according to the invention for a notification system to provide information data for an application of a terminal are described in detail below with reference to the accompanying figures, in which:

FIG. 1 shows a schematic depiction of a conventional asynchronous notification system;

FIG. 2 shows a schematic depiction of a conventional system for providing information data via a proprietary delivery system;

FIG. 3 shows a flowchart to depict an exemplary embodiment of the method according to the invention for providing information data;

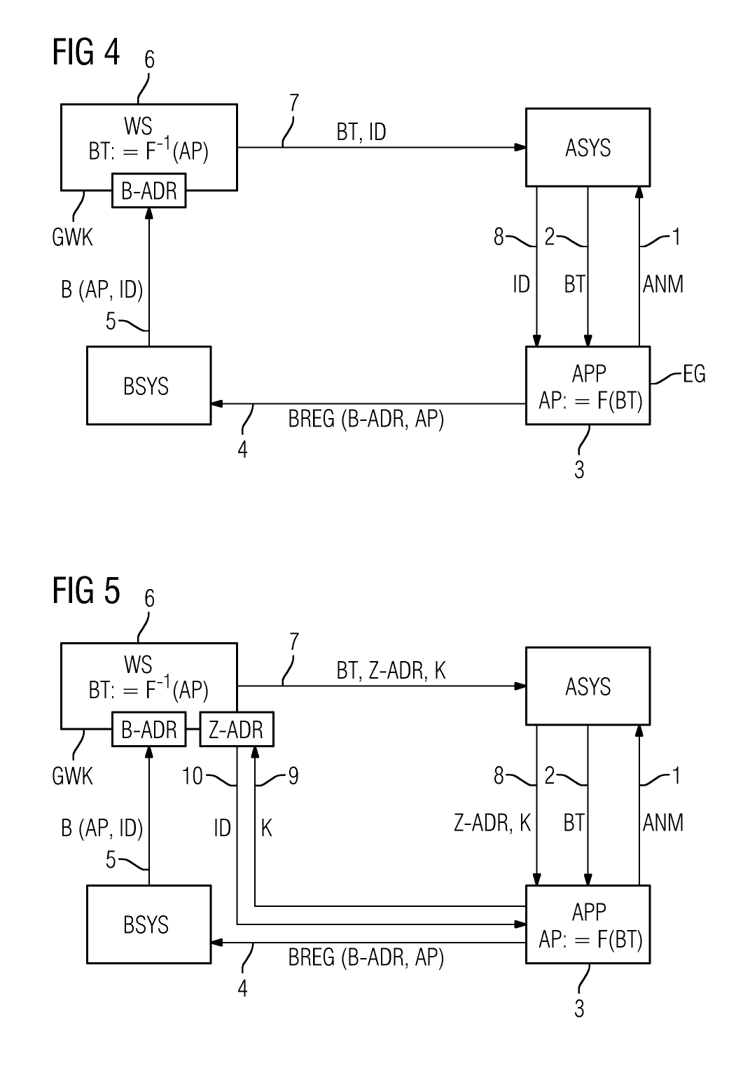

FIG. 4 shows a schematic depiction of a first exemplary variant embodiment of the method according to the invention and of the information system according to the invention for providing information data;

FIG. 5 shows a schematic depiction of a further exemplary variant embodiment of the method according to the invention and of the information system according to the invention for providing information data.

In the figures, like reference symbols represent like components, unless indicated otherwise.

FIG. 3 schematically shows a flowchart to depict an exemplary embodiment of the method according to the invention for a notification system to provide information data for an application of a terminal.

In a first step S1, a notification system BSYS receives a notification registration BREG from a terminal EG during the registration of the terminal with the notification system BSYS. This notification registration BREG has a notification address B-ADR for addressing a web service WS provided by a gateway component and also a call parameter AP. In this case, the call parameter AP is preferably dependent on a notification token BT of the terminal EG. In one possible embodiment, the terminal EG, after the terminal signs in on a delivery system ASYS, obtains an explicit notification token BT from the relevant delivery system ASYS. An application APP of the terminal EG can then generate the call parameter AP from the obtained notification token BT and can transmit said call parameter together with a notification address B-ADR in the notification registration BREG to the notification system B SYS.

The notification system BSYS receives this notification registration B-REG from the terminal EG in step S1. The notification registration BREG essentially comprises a particular notification address B-ADR and the call parameter AP. The notification address B-ADR is preferably a network-compliant URL (Uniform Resource Locator). The notification address B-ADR is in this case preferably formed by concatenation of an address of the gateway component, a port number of the web service WS, an address path for calling the relevant web service WS and the call parameter AP. The address of the gateway component GWK is a host name or IP address of the gateway component GWK. The port number PN indicates the port on which the relevant web service WS can be reached. The address path for calling the web service WS preferably indicates a path to the respective resources to which the relevant web service WS is attached. The call parameter AP is preferably generated by the terminal EG by virtue of a prescribed generator function F being applied to the obtained notification token BT. The call parameter AP is formed by a string or a character string, for example, that is generated by the generator function F on the terminal EG. During the registration process of the terminal, the notification system BSYS obtains the notification registration BREG with the notification address B-ADR included therein, resulting from concatenation, and also the generated call parameter AP. The notification system stores the notification address B-ADR and the associated call parameter AP in a memory unit.

In a further step S2, the notification system BSYS sends a notification B to the notification address B-ADR included in the notification registration BREG. This notification B includes information data ID as notification content BI. The sending of the notification B is preferably triggered by an event. In one possible embodiment, the notification system BSYS obtains a value, for example a signal value, that can trigger the sending of the notification B. By way of example, the obtained signal value is evaluated in accordance with an evaluation rule AR in order to check whether the event has occurred. By way of example, a signal value can be compared with a signal threshold value TH according to a prescribed evaluation rule AR. As soon as the received signal value exceeds the threshold value, the relevant event has occurred and the sending of the notification B by the notification system BSYS is triggered. The applicable evaluation rules AR may be stored in a local memory of the notification system BSYS. In one possible embodiment, the evaluation rules AR are configurable. In a further possible embodiment, the notification system BSYS obtains one or more evaluation rules AR from the application APP of a terminal EG, for example when the terminal EG registers with the respective notification system BSYS. In this embodiment, the evaluation rules AR can be altered dynamically or over the course of time by an application APP of a terminal EG. The values or data that are evaluated by the evaluation rules AR can be obtained by the notification system BSYS from various data sources, in particular sensors.

The notification system BSYS uses the notification address used in the notification registration BREG in order to transmit the notification B. By way of example, an HTTP POST can be effected on this notification address or URL.

As soon as the gateway component GWK has obtained the notification B, the web service WS of the gateway component GWK that is addressed by the notification address B-ADR derives the original notification token BT from the call parameter AP included in said notification in step S3. This is accomplished in one possible embodiment by virtue of the addressed web service of the gateway component GWK applying an inverse function F⁻¹ for the prescribed generator function F to the obtained call parameter AP. The gateway component GWK is a component or unit that converts or transforms the received notification B into a different notification format. The gateway component therefore forms a notification format transformation unit. As soon as the notification token BT has been derived from the obtained call parameter AP by the addressed web service WS, the gateway component transmits the derived notification token BT together with the obtained information data ID or an access address for accessing these information data to a delivery system ASYS in step S3.

In step S4 of the exemplary embodiment depicted in FIG. 3 for the method according to the invention, the delivery system ASYS uses the notification token BT obtained from the gateway component GWK to identify the relevant terminal EG and forwards the obtained information data ID or the obtained access address Z-ADR for accessing the information data ID to the application APP of the identified terminal EG. The application or the application program that is executed on the terminal EG therefore obtains information data ID from the notification system BSYS via its proprietary delivery system ASYS. This is made possible by the provision of the gateway component GWK between the notification system BSYS and the proprietary delivery system ASYS, by virtue of a notification format conversion being effected in the gateway component GWK. The gateway component GWK provides an addressable web service WS that is called by a URL that the terminal EG has used previously in its notification registration BREG. This expressly requires no communication between the terminal EG and the gateway component GWK. The URL scheme agreed bilaterally beforehand makes it possible to ensure that the terminal EG has knowledge of which URL needs to be chosen for the notification B. In the same manner, the gateway component GWK has information concerning the URL to which or by means of which it attaches or provides the relevant web service WS. The URL scheme includes a variable part influenced by the token or notification token BT. This is not required for calling the relevant web service, however. Instead, precisely this variable part is transferred to the web service WS as a call parameter AP. This is possible as a result of JAX-RS implementation, for example.

In many applications, the length of the notification B or the amount of information data ID included therein is limited to a maximum amount of data of a few hundreds bytes, for example, for reasons of efficiency. Sometimes, notifications B of a conventional notification system BSYS can be much longer, however, in particular if XML is used as the data format. In this case, the gateway component GWK can appear as a buffer store for the terminal EG and can provide the actual notification B to a URL address or callback address, as depicted schematically in FIG. 5.

FIG. 4 schematically shows a first variant embodiment of the method and system according to the invention for a notification system BSYS, particularly a conventional notification system BSYS, as depicted in FIG. 1, to provide information data. First of all, the terminal EG signs in (1) on a proprietary delivery system or forwarding system ASYS and obtains (2) from the delivery system ASYS a token or a notification token BT. This notification token BT is explicit and requires identification of the relevant terminal EG. The delivery system ASYS may be a proprietary delivery system, for example an Apple Push Notification Service system, APNS. In the exemplary embodiment depicted, the terminal EG generates (3) a call parameter AP by virtue of a prescribed generator function F being applied to the obtained notification token BT. The terminal EG subsequently registers (4) with a notification system BSYS during its registration process to obtain notifications (B) in future, for example when particular events occur. During a registration process or subscription process, the terminal EG transmits a notification registration BREG that has a notification address B-ADR and the generated call parameter AP. The notification address B-ADR is used to address a web service WS provided by the gateway component GWK. The notification system BSYS receives the notification registration BREG and stores the obtained call parameter AP and also the notification address B-ADR in a local memory. In addition, the notification system BSYS can obtain one or more evaluation rules AR from the terminal EG in one possible variant embodiment. Using these evaluation rules AR, the notification system BSYS can check whether received data or values comply with these rules AR and therefore an event EG has occurred that requires a notification or information data to be provided for the relevant terminal EG. Alternatively, the evaluation rules AR may also be preconfigured in the notification system. As soon as the event has occurred, the notification system BSYS sends (5) at least one notification B to the notification address B-ADR, stored in the local memory, that the notification system obtained from the terminal EG during the notification registration BREG. This notification B includes information data ID that are provided or generated by the notification system BSYS.

The gateway component GWK provides a web service WS that is addressed by the notification address B-ADR and derives (6) a notification token BT from the transferred call parameter AP. The gateway component GWK subsequently transmits (7) the derived notification token BT together with the information data ID to the proprietary delivery system ASYS, as depicted in FIG. 4. The proprietary delivery system ASYS identifies the terminal EG on the basis of the notification token BT obtained from gateway component GWK and forwards (8) the likewise received information data ID to the application APP of the identified terminal EG. Information data ID comprise, by way of example, traffic-related and/or environment-related data for a navigation application for route calculation using push mode, which navigation application is executed on the terminal EG having limited communication capability. The delivery system ASYS is an APNS system, for example.

FIG. 5 shows a further exemplary embodiment of the method according to the invention and of the system according to the invention for providing information data.

In this variant embodiment, the terminal EG, when signing in (1) on the proprietary delivery system ASYS, likewise obtains a notification token BT (2), from which a call parameter AP is derived (3). Just as in the variant embodiment depicted in FIG. 4, the terminal EG registers (4) with a notification system BSYS during a notification registration and in so doing transfers a notification address B-ADR and also the generated call parameter AP. When the event occurs, the notification system BSYS sends (5) a notification B that comprises information data ID as notification content BI. The notification B further includes the transferred call parameter AP. The notification B is transmitted to the notification address B-ADR as in the case of the variant embodiment depicted in FIG. 4, with the web service WS addressed in the gateway component GWK deriving (6) the original notification token BT from the obtained call parameter AP. In contrast to the variant depicted in FIG. 4, the gateway component GWK in the variant embodiment depicted in FIG. 5 does not forward the information data ID to the proprietary delivery system ASYS, but rather forwards an access address or callback address Z-ADR. In addition, the gateway component GWK generates (6) for the obtained notification B an associated key, in particular a cryptographic key K, if the amount of data in the notification B obtained from the notification system BSYS exceeds an admissible maximum amount of data. Further, the gateway component GWK stores the notification content BI of the obtained notification B, i.e. the information data ID, together with the associated key K for referencing the respective notification content BI in a local memory of the gateway component GWK. The gateway component GWK generates for the notification B obtained from the notification BSYS an access or callback address Z-ADR for accessing the information data ID included in the notification B as notification content BI if the amount of data in the notification B obtained from the notification system BSYS exceeds an admissible prescribed maximum amount of data. The gateway component GWK identifies from the transmitted notification content BI or the information data ID that it exceeds an admissible maximum size. In this case, the gateway component GWK now generates a random cryptographic key K, for example using a cryptographic hash function H. This cryptographic key K is used precisely a single time and is not easily decryptable. The notification B is then stored with the generated key K as a reference in a local memory of the gateway component GWK. The gateway component GWK can now generate a URL that, in the address of the gateway component GWK comprises a port number PN of the relevant web service WS, an address path for calling the web service WS and a character representation of the key K. This character representation, as a character string, can use only such characters as can also be used in a URL. The gateway component GWK now sends (7), rather than the original message, a new message that includes this URL together with the notification token BT to the delivery system ASYS of the terminal EG. The gateway component generates for the notification B obtained from the notification system BSYS an access address or callback address Z-ADR for accessing the information data ID included in the notification B as notification content. The gateway component GWK transmits (7) the generated access address Z-ADR for accessing the information data ID obtained in the obtained notification B, which comprises the generated key K, together with the notification token BT derived from the notification address B-ADR to the delivery system ASYS. The delivery system ASYS uses the received notification token BT to identify the relevant terminal EG and forwards (8) the obtained access address Z-ADR or callback address, including the key K, to the application APP of the identified terminal EG, as depicted in FIG. 5. The application APP of the identified terminal EG calls (9) the web service WS of the gateway component GWK that is addressed in the access address Z-ADR. The terminal EG uses the web service URL for a web service call on the gateway component GWK, the web service call including the cryptographic key K. The gateway component GWK uses the cryptographic key K taken from the web service call to reference the associated notification content BI, stored in the local memory of the gateway component GWK, of the original notification B provided by the notification system BSYS. The notification content BI referenced by the key K and comprising the information data ID is read from the local memory of the gateway component GWK by the called web service WS and transmitted (10) to the application APP of the terminal EG to evaluate the information data ID, as depicted in FIG. 5.

The gateway component GWK depicted in FIGS. 4 and 5, which performs conversion of the notification B into a suitable notification format, may be integrated in a server of a service provider together with the notification system BSYS in one possible embodiment. In one possible embodiment, the information system according to the invention is integrated in a sensor web system that provides intelligent traffic services. A notification system or data platform provides traffic-related and/or environment-related information data ID, with drivers using an application APP, in particular a navigation application, to use these information data ID on an IOS terminal, in particular an iPad or an iPhone. By way of example, a navigation application implemented on an IOS terminal can register to obtain specific information data ID that are relevant to a current route of a vehicle. The navigation application then obtains a notification B or information data ID upon particular events in the relevant area and can then change the route guidance. The notification system BSYS of the sensor web system can use the method according to the invention to send information data ID in push mode to an IOS terminal EG too and can therefore allow the route calculation.

The method according to the invention and the system according to the invention can be used for any event-controlled processes. The method according to the invention allows conventional notification systems BSYS, such as OGC SES, for example, to be rendered capable of supplying applications APPs that run on IOS terminals EG with information data ID. This has not been possible to date, since the mechanism of notification by executing an HTTP POST on a URL that is used by OGC SES, for example, is not compatible with the proprietary APNS system. APNS uses message formats that provide for the use of certificates for identification and authorization. Furthermore, an IOS terminal needs to transmit a secret token to the notifying unit, which needs to use it for addressing. There is likewise no provision for this in the OGC SES specification. The method according to the invention introduces a mechanism that allows forwarding of a token, in particular a notification token, by a conventional system, in particular OGC SES system, to the gateway component GWK, so that the actual notification receiver can be addressed.

1. A method for a notification system to provide information data for an application of a terminal, the method comprising:
receiving by the notification system, a notification registration from the terminal when the terminal registers with the notification system the received notification registration having a notification address for addressing a web service provided by a gateway component and a call parameter that is dependent on a notification token of the terminal; and
sending, by the notification system, a notification that includes the information data as notification content to the notification address included in the notification registration.
wherein the web service of the gateway component that is addressed by the notification address derives the notification token from the obtained call parameter, the derived notification token transmitted together with the information data or an access address for accessing the information data a delivery system;
wherein the delivery system identifies the terminal on a basis of the obtained notification token, and the delivery system forwards the information data or the access address for accessing the information data to the application of the identified terminal.

2. The method as claimed in claim 1, wherein the terminal obtains an explicit notification token from the delivery system after the terminal has signed in on the delivery system.

3. The method as claimed in claim 1, wherein the terminal generates the call parameter by virtue of a prescribed generator function being applied to the obtained notification token.

4. The method as claimed in claim 1, wherein the notification address is formed by concatenation of an address of the gateway component, a port number of the web service, an address path for calling the web service and the call parameter.

5. The method as claimed in claim 1, wherein the notification that is sent by the notification system and includes the information data as notification content is triggered by an event.

6. The method as claimed in claim 3, wherein the web service of the gateway component that is addressed by the notification address derives the notification token from the obtained call parameter by virtue of an inverse function of the prescribed generator function being applied to the call parameter.

7. The method as claimed in claim 1, wherein the gateway component generates an associated key for an obtained notification if the amount of data in the notification obtained from the notification system exceeds an admissible maximum amount of data, and stores the notification content of the obtained notification together with the associated key for referencing the notification content in a local memory of the gateway component.

8. The method as claimed in claim 7, wherein the gateway component generates for the notification obtained from the notification system an access address for accessing the information data included in the notification as notification content if the amount of data in the notification obtained from the notification system exceeds an admissible maximum amount of data.

9. The method as claimed in claim 8, wherein the gateway component transmits the generated access address for accessing the information data obtained in the obtained notification, which has the generated key, together with the notification token derived from the notification address to the delivery system, which uses the notification token to identify the terminal and forwards the access address, including the key, to the application of the identified terminal.

10. The method as claimed in claim 8, wherein the access address for accessing the information data is generated by the gateway component by concatenation of an address of the gateway component, a port number of the web service, an address path for calling the web service and the key generated for the notification.

11. The method as claimed in claim 8, wherein the application of the identified terminal the web service of the gateway component that is addressed in the access address, said gateway component using the key included in the access address to reference the associated notification content of the notification that is stored in the local memory of the gateway component.

12. The method as claimed in claim 11, wherein the notification content of the notification that is referenced by the key is read from the local memory of the gateway component by the called web service and transmitted to the application of the terminal to evaluate the information data that form the notification content.

13. The method as claimed in claim 7, wherein the gateway component generates the key by means of a cryptographic hash function.

14. An information system for a notification system to provide information data for at least one application of a terminal having limited communication capability, wherein the notification system is designed to automatically send a notification that includes information data as notification content to a notification address that comes from a notification registration for registering the terminal with the notification system that has the notification address for addressing a web service provided by a gateway component and a call parameter that is dependent on a notification token of the terminal, wherein the web service of the gateway component that is addressed by the notification address derives the notification token from the obtained call parameter and transmits the notification token together with the information data or an access address for accessing the information data to a delivery system that is designed to identify the terminal on a basis of the obtained notification token and to forward the information data or the access address for accessing the information data to the application of the identified terminal.

15. The information system as claimed in claim 14, wherein the notification system and the gateway component are integrated in a server of a service provider.

16. The information system as claimed in claim 14, wherein the delivery system is a proprietary delivery system.

17. The information system as claimed in claim 14, wherein the terminal is a terminal having limited communication capability for push mode, particularly an IOS device.

18. The information system as claimed in claim 14,
wherein the information system provides traffic-related and/or environment-related data to a navigation app for route calculation using push mode, which navigation app is executed on a terminal having limited communication capability, as information data.

19. A gateway component for an information system as claimed in claim 14, wherein the gateway component receives a notification from a notification system via a notification address for addressing a web service provided by the gateway component, which notification has a call parameter that is dependent on a notification token of a terminal, wherein the addressed web service derives the notification token of the terminal from the call parameter and transmits the derived notification token together with the notification content of the received notification or an access address for accessing the notification content of the received notification to a delivery system of the terminal.
